(19) United States
(12) Patent Application Publication
(10) Pub. No.: US 2003/0167900 A1
(43) Pub. Date: Sep. 11, 2003

(54) Cymbal

(76) Inventor: Robert Paiste, Nottwil (CH)

Correspondence Address: GREENBLUM & BERNSTEIN, P.L.C., 1950 ROLAND CLARKE PLACE, RESTON, VA, 20191, US

(21) Appl. No.: 10/362,918

(22) PCT Filed: Aug. 21, 2001
(86) PCT No.: PCT/CH01/00512

(30) Foreign Application Priority Data
Aug. 28, 2000 (EP) 00118607.1

(51) Int. Cl. G10D 13/02

(52) U.S. Cl. 84/422.3

(57) ABSTRACT

Cymbals for percussion instruments generally comprise an umbrella-like annular area (3), which is at least approximately circular, and comprise a central convex dome (5). According to the invention, at least portions of the cymbal surface have non-contiguous and/or irregular structural elements (9), which extend, for example, in a circumferential direction. The structural elements are preferably little notches that are produced by means of a rotating milling tool.

The present invention relates to a cymbal according to the preamble according to claim 1, which is primarily used as a percussion instrument or in combination with percussion instruments such as in particular drums and the like.

Cymbals, which are chiefly made either of bronze, i.e. a copper/tin alloy, or other copper alloys or optionally another suitable metal or a metal alloy, are as a rule provided on their surface with one or more grooves produced by machining, which grooves extend largely concentrically on the cymbal surface, running from outside to inside. A specific sound is made by these grooves produced by machining.

In U.S. Pat. No. 6,034,313 a cymbal is proposed that features on its surface a plurality of linear, tonal nicks. These run as a rule radially, linearly from the center of the cymbal surface towards the outer edge.

Due to the continual new trends in musical styles and in particular the use of percussion and rhythm instruments in a great variety of musical fields, there is a permanent desire to develop ever new sound characteristics, i.a. also for cymbals.

It is therefore an object of the present invention to create a cymbal with a new sound characteristic.

According to the invention the object is attained by means of a cymbal according to the wording of claim 1.

Instead of using a machining tool such as for example a cutting tool to produce a largely continuous groove on the cymbal surface, it is proposed according to the invention to use for example a milling tool, by means of which a non-continuous or irregularly continuous structure is formed that runs in the circumferential direction of the cymbal surface. The resulting structural element can be ultra-small nicks that as disconnected grooves extend, for example, from outside to inside on the outer or upper surface respectively, or inner or lower surface respectively, of the cymbal. These irregular and/or disconnected structural elements can be arranged over the entire upper or lower surface of the cymbal, or else over part of the surface, for example as ring-like segments that extend concentrically on the surface of the cymbal.

The irregular and/or disconnected structures proposed according to the invention are preferably produced by means of a rotating tool such as for example by means of a rotating milling tool or milling head.

The invention is now explained in more detail below by way of example and with reference to the attached Figures.

The Figures show:

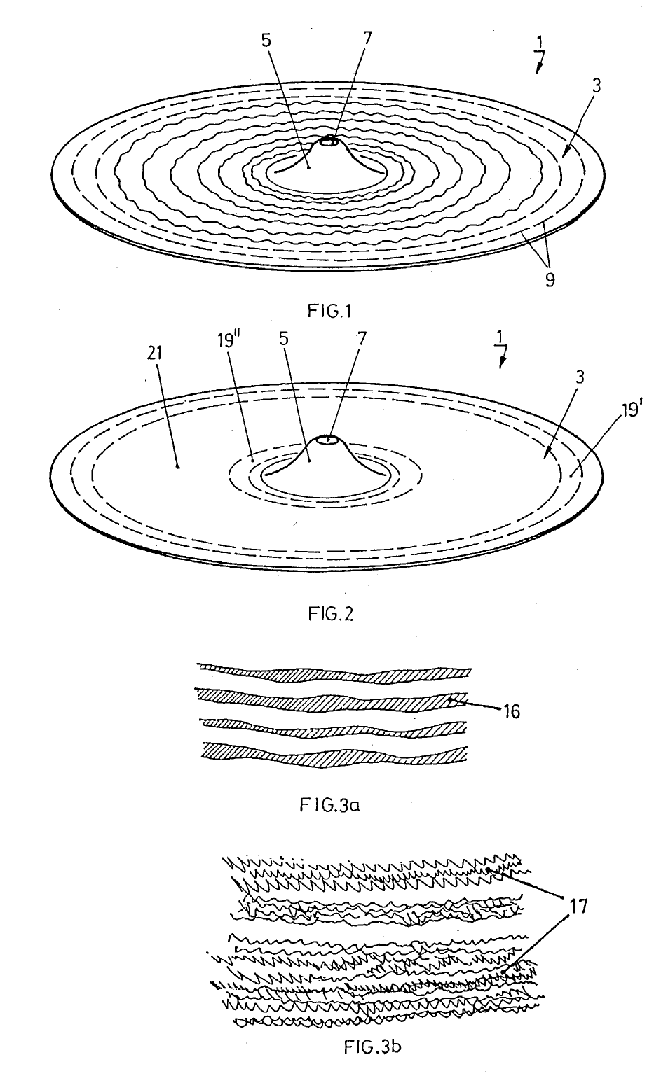

FIG. 1 In perspective, in plan view, a cymbal embodied according to the invention;

FIG. 2 A further embodiment variant of a cymbal according to the invention;

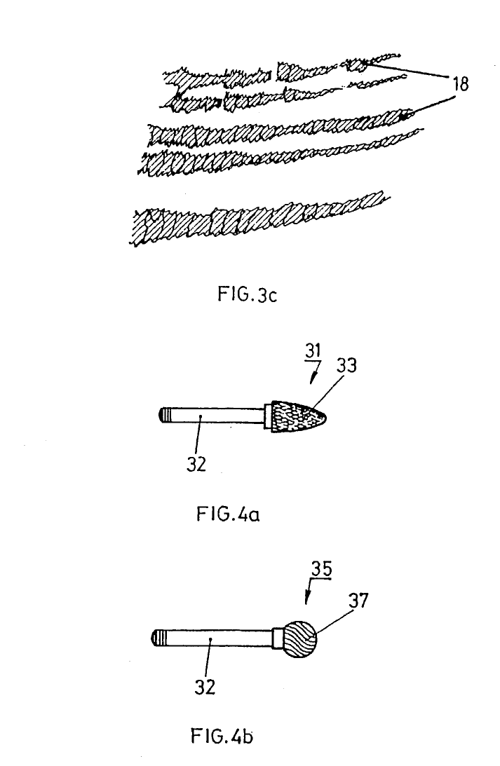

FIG. 3a, 3b and 3c Surface structures, whereby FIG. 3a shows conventionally known grooves, whereas in FIGS. 3b and 3c disconnected structures according to the invention are shown, and

FIGS. 4a and 4b Possible milling heads that can be used to produce the surface structures according to the invention.

FIG. 1 shows a cymbal 1 that features a ring area 3 domed in an umbrella-like manner as well as a central cupola 5 featuring a central hole 7, for example for arranging the cymbal hanging on a stand. The disconnected structures 9 are now shown schematically in particular on the umbrella-like ring area 3, which structures extend largely over the entire surface on this ring area in the circumferential direction.

FIG. 2 shows a further embodiment variant whereby a disconnected structure 19′ according to the invention is arranged at the outer edge of the umbrella-like ring area 3 as well as centrally in the area of the transition to the central cupola 5. Between the two ring-segment-like areas 19′ and 19″ provided with the structure according to the invention, there extends a ring-like area 21 that either can be completely flat, or can feature a hammered structure, or else a groove-like structure as known for conventional cymbals. Of course, the representation according to FIG. 2 is merely by way of example, and it is absolutely possible to arrange several ring-segment-like areas embodied according to the invention, or else the ring-segment-like areas at places other than those shown in FIG. 2.

In FIG. 3a a conventional groove structure is shown schematically, as is well known from the prior art.

In contrast, FIGS. 3b and 3c show surface structures according to the invention, whereby in comparison with FIG. 3a is it clearly discernible that the structure in FIG. 3b is irregular and that in FIG. 3c is partly disconnected and comprises individual nicks 17 or 18, whereas the continuous grooves 16 are discernible in FIG. 3a.

Sound comparisons between cymbals featuring grooves according to the prior art and cymbals featuring the disconnected structure proposed according to the invention, show distinct differences. The sound produced by means of the cymbals according to the invention is coarser, less linear, earthier, more sustained, and the sound decay is less. In particular a different vibration behavior is evident in the cymbal according to the invention, compared with a conventional cymbal featuring grooves.

In contrast to the machining cutting tool customarily used to produce the structure according to FIG. 3a, a rotating tool such as, for example, a rotating milling tool or a milling head is preferably used to produce the irregular or disconnected structures according to FIGS. 3b and 3c.

In FIGS. 4a and 4b, two examples of such a milling head 31 or 35 are shown, in which a corresponding conical milling head 33 or a largely spherical milling head 37, each featuring milling grooves, is respectively arranged on a spindle 32.

Of course, the milling heads in FIGS. 4a and 4b are merely examples to better explain the present invention.

The cymbals and milling heads shown in FIGS. 1 through 4 are, of course, only examples in order to explain the present invention. In particular the invention is also independent of the metal or the metal alloy used to produce the cymbals. Bronzes are used as a rule, but it is also possible, of course, to produce cymbals from brass or other metals or metal alloys.

The geometrical arrangement of the disconnected structure is not per se specified either, thus it is possible to arrange the structure over the entire surface, on partial surfaces, with a higher or lower density, in the form of ring segments, etc. The depth of penetration of the disconnected structure can also be varied, in accordance with the sound to be produced.

1. Cymbal for percussion instruments, featuring an at least almost round, umbrella-like ring area (3) as well as a central domed cupola (5), characterized in that at least parts of the cymbal surface feature non-continuous and/or irregular structural elements (9, 17, 19′, 19″) running in the circumferential direction, whereby the structural elements comprise nicks produced by means of a milling tool (31, 35).

2. Cymbal according to claim 1, characterized in that the structural elements (9, 17, 19′, 19″) are ultra-small nicks.

3. Cymbal according to one of claims 1 or 2, characterized in that the structural elements are arranged in the form of ring segments (19′, 19″) and/or over part of the surface.

4. Cymbal according to one of claims 1 through 3, characterized in that the density of the structural elements locally is largely the same or different.

5. Cymbal according to one of claims 1 through 4, characterized in that the structural elements are arranged on the outer or upper surface respectively, and/or the inner or lower surface respectively.

6. Cymbal according to one of claims 1 through 5, characterized in that on the surface, in addition to non-continuous and/or irregular structural elements, continuous grooves and/or hammered areas and/or other types of worked surface areas are present.

7. Method for the production of a cymbal (1), in particular according to one of claims 1 to 6, characterized in that the surface treatment is carried out by means of a rotating tool.

8. Method according to claim 7, characterized in that the surface is worked partially or at least almost over the entire surface by means of a rotating milling tool or milling head (31, 35) from outwards to inwards or inwards to outwards.

9. Method according to one of claims 7 or 8, characterized in that the rotating tool is guided more or less strongly against the cymbal surface during the surface working, to produce smaller or greater depths of penetration of the individual structural elements.
